(19) United States
(12) Patent Application Publication
(10) Pub. No.: US 2024/0169588 A1
(43) Pub. Date: May 23, 2024

(54) METHOD AND APPARATUS FOR DETECTING AND CORRECTING POSITIONING ERRORS OF SENSED OBJECTS IN REAL TIME IN INFRASTRUCTURE SENSORS

(71) Applicant: KOREA NATIONAL UNIVERSITY OF TRANSPORTATION Industry-Academic Cooperation Foundation, Chungju (KR)

(72) Inventor: Cheol MUN, Yongin (KR)

(73) Assignee: KOREA NATIONAL UNIVERSITY OF TRANSPORTATION Industry-Academic Cooperation Foundation, Chungju (KR)

(21) Appl. No.: 18/515,418

(22) Filed: Nov. 21, 2023

(30) Foreign Application Priority Data
Nov. 23, 2022 (KR) 10-2022-0158564

(51) Int. Cl. G06T 7/80; G06F 11/07; G06V 10/75

(52) U.S. Cl. CPC G06T 7/80; G06F 11/0772; G06V 10/7515; G06T 2207/30184

(57) ABSTRACT

The present invention relates to a method and an apparatus for detecting and correcting positioning errors of sensed objects in real time in infrastructure sensors. A method for detecting and correcting positioning errors of sensed objects in real time in infrastructure sensors may include: (a) acquiring an image from an infrastructure sensor; (b) determining a first pixel corresponding to a corner of each object included in the image, and a second pixel which does not correspond to the corner of the object; (c) generating a binary matrix corresponding to the first pixel and the second pixel; and (d) calibrating an absolute coordinate of the image according to a similarity based on the binary matrix.

### CROSS-REFERENCE TO RELATED APPLICATIONS

This application claims the priority of Korean Patent Application No. 10-2022-0158564 filed on Nov. 23, 2022, in the Korean Intellectual Property Office, the disclosure of which is incorporated herein by reference.

### BACKGROUND OF THE INVENTION

### Field of the Invention

The present invention relates to a method and an apparatus for detecting and correcting positioning errors of sensed objects in real time in infrastructure sensors, and more particularly, to a method and an apparatus for detecting and correcting positioning errors of sensed objects due to movement of infrastructure sensors in real time.

### Description of the Related Art

An autonomous vehicle uses sensors such as cameras, Lidars, and radars mounted on a vehicle to recognize and judge a surrounding situation and control the vehicle to move to a desired path.

However, the camera, Lidar, and radar mounted on the vehicle use light, lasers, and radio waves, so they cannot be aware of a situation in a blind area, which is invisible.

Therefore, cooperative sensing technology is developed in which infrastructure sensors (e.g., cameras, lidar, etc.) are aware of the situation in an area where there is a blind spot of a vehicle sensor, such as urban intersections, joining roads, etc., and cognitive information of the infrastructure sensor is delivered to the vehicle by using V2X communication.

In the case of the prior art, when the infrastructure sensor extracts all objects on the roads of an area of interest, estimates the locations of the extracted objects, grants IDs to the objects, and delivers the IDs to the Multi-ACCESS Edge Computing (MEC), if the MEC tracks a trajectory on which multiple objects move to estimate a movement direction and a movement speed, and delivers cognized information to a road side base station, the road side base station can prepare situation cognition information as a cooperative sensing message, and transmit the cooperative sensing message to surrounding vehicles through V2X communication.

In particular, a research into a process in which by using an absolute coordinate of a sample point (as a point easy to specify in an image, a corner of a main road marking line, etc.) obtained by offline in estimating the location of the extracted object, the absolute coordinate is mapped to the same sample point of the image, and interpolated and extrapolated based on absolute coordinates for multiple sample points to extract and store absolute coordinates for all pixels of the image, i.e., an absolute coordinate calibration is underway.

However, in the conventional case, there is a problem that the positional error of the object occurs according to the movement of the infrastructure sensor, and a research for resolving the problem, but is insufficient.

### SUMMARY OF THE INVENTION

The present invention is contrived to solve the above-mentioned problem, and has been made in an effort to provide a method and an apparatus for detecting and correcting positioning errors of sensed objects in real time in infrastructure sensors.

Further, the present invention has been made in an effort to provide a method and an apparatus for detecting whether the positioning errors occur in real time as the infrastructure sensor autonomously continuously determines whether calibrated absolute coordinates are valid, and when the positioning errors occur, correcting the positioning errors.

The objects of the present invention are not limited to the aforementioned objects, and other objects, which are not mentioned above, will be apparent from the following description.

In order to achieve the objects, an exemplary embodiment of the present invention provides a method for detecting and correcting positioning errors of sensed objects in real time in infrastructure sensors, which may include: (a) acquiring an image from an infrastructure sensor; (b) determining a first pixel corresponding to a corner of each object included in the image, and a second pixel which does not correspond to the corner of the object; (c) generating a binary matrix corresponding to the first pixel and the second pixel; and (d) calibrating an absolute coordinate of the image according to a similarity based on the binary matrix.

In the exemplary embodiment, step (c) above may include allocating an element corresponding to an absolute coordinate of the first pixel corresponding to the corner of the object with 1 and allocating an element corresponding to an absolute coordinate of the second pixel which does not correspond to the corner of the object with 0 to generate the binary matrix.

In the exemplary embodiment, step (d) above may include calculating a similarity between a binary matrix based on the image at a previous time point and a binary matrix of the image at a current time point, and maintaining the absolute coordinate of the image at the current time point when the similarity is larger than the threshold.

In the exemplary embodiment, step (d) above may include controlling a control server to transmit a positioning error occurrence message by the infrastructure sensor when the similarity is smaller than the threshold.

In the exemplary embodiment, step (d) above may include calculating, when the similarity is smaller than the threshold, a similarity based on a direction for acquiring the image of the infrastructure sensor according to a 2D convolution of the binary matrix at the previous time point and the binary matrix at the current time point, calculating pixel information corresponding to the similarity based on the direction of the infrastructure sensor, and calibrating the absolute coordinate of the image at the current time point based on the pixel information.

Another exemplary embodiment of the present invention provides an apparatus for detecting and correcting positioning errors of sensed objects in real time in infrastructure sensors may include: an acquisition unit acquiring an image from an infrastructure sensor; and a control unit determining a first pixel corresponding to a corner of each object included in the image, and a second pixel which does not correspond to the corner of the object, generating a binary matrix corresponding to the first pixel and the second pixel, and calibrating an absolute coordinate of the image according to a similarity based on the binary matrix.

In the exemplary embodiment, the control unit may allocate an element corresponding to an absolute coordinate of the first pixel corresponding to the corner of the object with 1 and allocate an element corresponding to an absolute coordinate of the second pixel which does not correspond to the corner of the object with 0 to generate the binary matrix.

In the exemplary embodiment, the control unit may calculate a similarity between a binary matrix based on the image at a previous time point and a binary matrix of the image at a current time point, and maintain the absolute coordinate of the image at the current time point when the similarity is larger than the threshold.

In the exemplary embodiment, the control unit may control a control server to transmit a positioning error occurrence message by the infrastructure sensor when the similarity is smaller than the threshold.

In the exemplary embodiment, the control unit may calculate, when the similarity is smaller than the threshold, a similarity based on a direction for acquiring the image of the infrastructure sensor according to a 2D convolution of the binary matrix at the previous time point and the binary matrix at the current time point, calculate pixel information corresponding to the similarity based on the direction of the infrastructure sensor, and calibrate the absolute coordinate of the image at the current time point based on the pixel information.

Specific details for achieving the above objects will become clear with reference to embodiments to be described later in detail in conjunction with the accompanying drawings.

However, the present invention is not limited to an exemplary embodiment disclosed below but may be implemented in various different shapes and the present embodiment just completes a disclosure of the present invention and is provided to completely inform a scope of the present invention to those skilled in the art to which the present invention belongs (hereinafter, referred to as “those skilled in the art”) .

According to an exemplary embodiment of the present invention, in an apparatus that implements cooperative sensing technology which delivers position and movement state information of objects on a road sensed by an infrastructure sensor to a vehicle by using V2X communication, it can be detected in real time that an error occurs in an existing absolute coordinate due to shaking of the infrastructure sensor or distortion of a sensor direction by wind and vibration, and as a result, position estimation errors for the objects on the road occur, and the position estimation error can be corrected.

The effects of the present invention are limited to the above-described effects, and the potential effects expected by the technical features of the present invention will be clearly understood from the description below.

### BRIEF DESCRIPTION OF THE DRAWINGS

FIG. 1 is a diagram illustrating a system for detecting and correcting positioning errors of sensed objects in infrastructure sensors according to an exemplary embodiment of the present invention.

FIG. 2 is a diagram illustrating an example of object positioning error calibration according to an exemplary embodiment of the prior art.

FIG. 3 is a diagram illustrating an example of real-time detection and correction of positioning errors of sensed objects in infrastructure sensors according to an exemplary embodiment of the present invention.

FIG. 4 is a diagram illustrating an example of corner detection of an image according to an exemplary embodiment of the present invention.

FIG. 5 is a diagram illustrating a process for detecting and correcting positioning errors of sensed objects in infrastructure sensors according to an exemplary embodiment of the present invention.

FIG. 6 is a diagram illustrating a method for detecting and correcting positioning errors of sensed objects in infrastructure sensors according to an exemplary embodiment of the present invention.

FIG. 7 is a diagram illustrating a functional configuration of an apparatus for detecting and correcting positioning errors of sensed objects in infrastructure sensors according to an exemplary embodiment of the present invention.

### DETAILED DESCRIPTION OF THE PREFERRED EMBODIMENT

The present invention may have various modifications and various exemplary embodiments and specific exemplary embodiments will be illustrated in the drawings and described in detail.

Various features of the invention disclosed in the claims may be better understood in consideration of the drawings and detailed description. Devices, methods, manufacturing methods, and various embodiments disclosed in the specification are provided for illustrative purposes. The disclosed structural and functional features are intended to enable a person skilled in the art to specifically implement various embodiments, and are not intended to limit the scope of the invention. The disclosed terms and phrases are intended to provide an easy-to-understand description of the various features of the disclosed invention, and are not intended to limit the scope of the invention.

In describing the present invention, a detailed description of related known technologies will be omitted if it is determined that they unnecessarily make the gist of the present invention unclear.

Hereinafter, a method and an apparatus for detecting and correcting positioning errors of sensed objects in infrastructure sensors according to an exemplary embodiment of the present invention will be described.

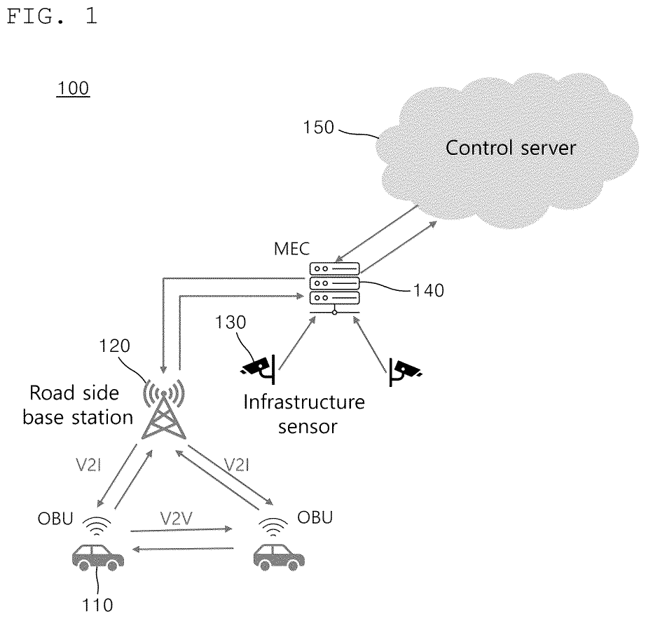

FIG. 1 is a diagram illustrating a system 100 for detecting and correcting positioning errors of sensed objects in infrastructure sensors according to an exemplary embodiment of the present invention.

Referring to FIG. 1, the system 100 may include a vehicle 110, a road side base station 120, an infrastructure sensor 130, multi-access edge computing (MEC) 140, and a control server 150.

The road side base station 120 may receive V2X communication information of each vehicle 110 from each vehicle 110 which is operated in a V2X service area.

The road side base station 120 may transmit the received V2X communication information the MEC 140.

The infrastructure sensor 130 may acquire an image for a traffic environment in which the vehicle 110 and the road side base station 120 are positioned. For example, when the infrastructure sensor 130 includes a camera, the infrastructure sensor 130 may photograph an image for the traffic environment.

In an exemplary embodiment, the infrastructure sensor 130 may acquire an image constituted by multiple frames, and in this case, each frame may include the image. In this case, an order of each image may be determined according to a time-series order.

In an exemplary embodiment, the infrastructure sensor 130 may detect and correct the positioning error of the object included in the image according to the movement of the infrastructure sensor 130 in real time.

In an exemplary embodiment, the infrastructure sensor 130 may transmit the acquired image to the MEC 140. The MEC 140 may detect and correct the positioning error of the object included in the image according to the movement of the infrastructure sensor 130 in real time.

In an exemplary embodiment, the MEC 140 may transmit the V2X communication information and the image to the control server 150.

In an exemplary embodiment, the road side base station 120 may be referred to as “road side unit (RSU)” or a term having an equivalent technical meaning thereto.

In an exemplary embodiment, the MEC 140 may be referred to as “edge node” or a term having an equivalent technical meaning thereto.

That is, when the infrastructure sensor 130 is shaken or a sensor direction is distorted by wind or vibration, the existing stored calibrated absolute coordinate does not become valid any longer, and when an absolute location of the object extracted by using the existing absolute coordinate is estimated, a position estimation error occurs.

Accordingly, when positional information including the error for the object on the road is delivered to the vehicles 110 from the infrastructure sensor 130, an accident may still occur, so according to the present invention, the infrastructure 130 or the MEC 140 may autonomously detect whether the positioning error occurs in real time, and when the positioning error occurs, correct the positioning error.

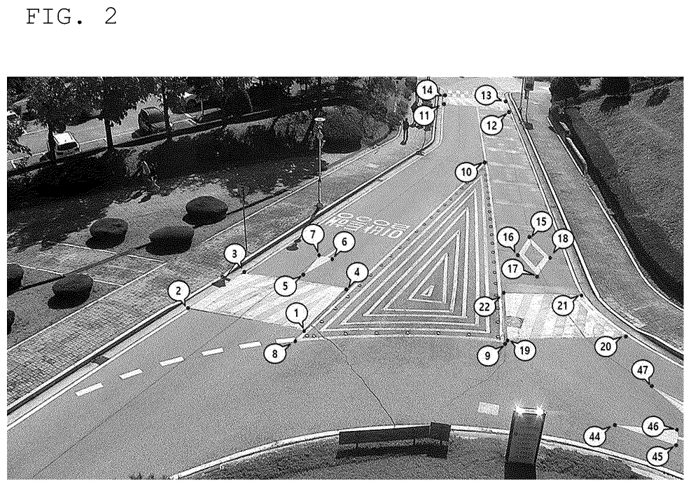

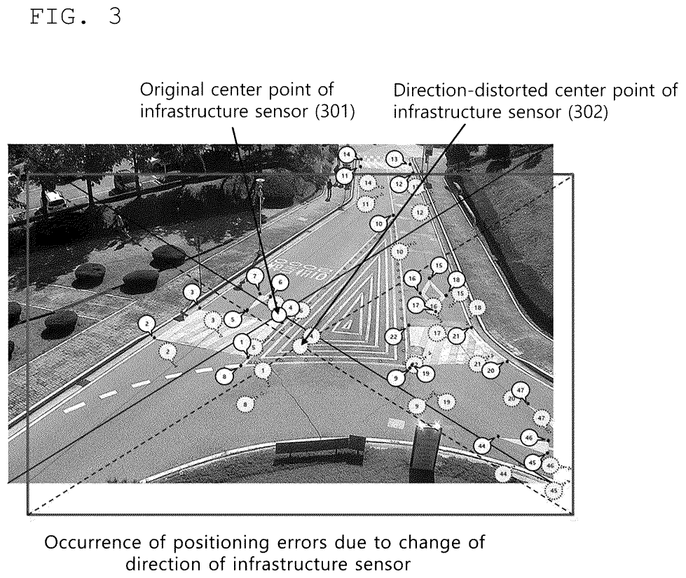

FIG. 2 is a diagram illustrating an example of object positioning error calibration according to an exemplary embodiment of the prior art. FIG. 3 is a diagram illustrating an example of real-time detection and correction of positioning errors of sensed objects in infrastructure sensors according to an exemplary embodiment of the present invention.

Referring to FIG. 2, in the conventional case, in the road side infrastructure sensor that identifies the object which moves on the road, and estimates the location, a general step of the calibration for determining the absolute coordinates for all pixels in an area of interest of the image may be performed as follows.

First, absolute coordinates for sample points (points #1 to 47 of FIG. 2) may be acquired through a high-precision map prepared offline.

Thereafter, coordinates of pixels corresponding to the sample points (points #1 to 47 of FIG. 2) may be mapped to the absolute coordinates in the camera or lidar image.

The absolute coordinates for all pixels in the area of interest may be calculated by interpolating or extrapolating the mapped absolute coordinates of the sample points (points #1 to 47 of FIG. 2).

Thereafter, by using the calibrated absolute coordinate, absolute coordinates corresponding to vertex pixels of a bounding box surrounding the object extracted from the image match one to one to estimate a location represented as the absolute coordinate for the object.

Referring to FIG. 3, due to the shaking of the infrastructure sensor or the distortion of the sensor direction due to the wind or vibration, a change or an error of the calibrated absolute coordinate may occur, and as a result, the position estimation error for the objects on the road may occur.

As a specific example, when a direction which the infrastructure sensor 130 (e.g., camera) faces is distorted and an original center point 301 of the infrastructure 130 set in the calibration step is thus changed to a center point 302, as in FIG. 3, if locations for the pixels corresponding to the sample points (points #1 to #47 marked with a yellow color in FIG. 3) are estimated based on the existing absolute coordinate, the locations are actually estimated with the absolute coordinates for the locations indicated by points #1 to #47 marked with a white color in FIG. 3.

Therefore, even when the direction which the infrastructure sensor 130 faces is changed, the positioning error may occur at the time of estimating the locations of the objects extracted based on the existing absolute coordinate.

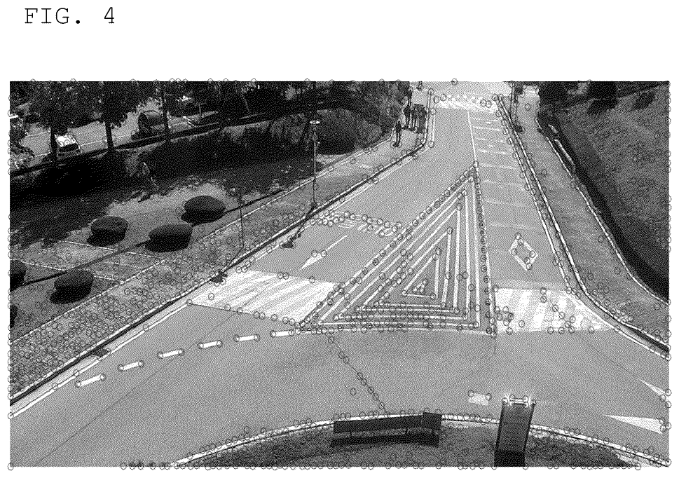

FIG. 4 is a diagram illustrating an example of corner detection of an image according to an exemplary embodiment of the present invention.

Referring to FIG. 4, a corner detection algorithm of extracting a portion recognized as a corner portion from the image is applied to confirm a result of representing a circling (O) marker in the corner extracted from the image.

In an exemplary embodiment, various corner detection algorithms may be used, and an appropriate algorithm may be selected and used.

In an exemplary embodiment, in the case of FIG. 4, the Harris corner detection algorithm may be used, and since the corner extracted by the corner detection algorithm has a unique value for each image, the corner may be used as a feature point in the image.

In an exemplary embodiment, the corner may include a corner portion or a protruded portion of each object.

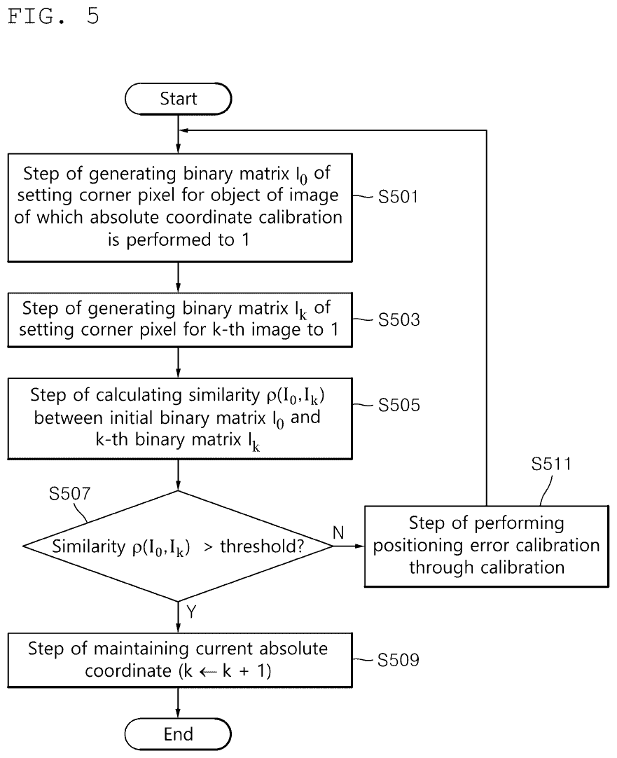

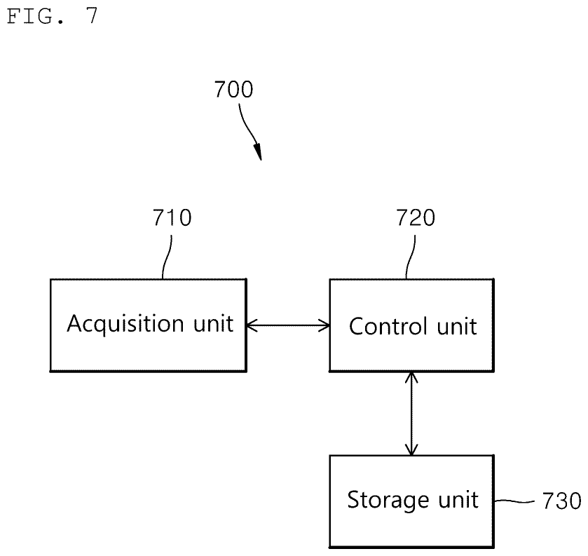

FIG. 5 is a diagram illustrating a process for detecting and correcting positioning errors of sensed objects in infrastructure sensors according to an exemplary embodiment of the present invention. In an exemplary embodiment, each step of FIG. 5 may be performed by an apparatus 700 of FIG. 7.

In step 501 of FIG. 5, a binary matrix I0 of setting a corner pixel for the object of the image in which the absolute coordinate is calibrated is generated. Here, the corner pixel may mean a pixel corresponding to the corner of each object included in the image.

In an exemplary embodiment, the binary matrix I0 may be referred to as “binary matrix” or a term having an equivalent technical meaning thereto.

In an exemplary embodiment after performing the calibration of estimating the absolute coordinates for all pixels in the area of interest of the image, corner detection for the image may be performed as in FIG. 4, and the binary matrix I0 may be generated in which an element corresponding to a pixel coordinate which belongs to the area of interest among the detected corners is allocated with 1 and an element which does not correspond to the corner is allocated with 0, and stored in a memory.

Here, the area of interest may be targeted for an object a road surface mark or structure which is not influenced by the wind or vibration. As an example, when the image is constituted by M horizontal pixels and N vertical pixels, a binary matrix having a size of M×N may be generated, and the element representing the pixel corresponding to the corner may be configured by 1 and the element representing the pixel which does not correspond to the corner may be configured by 0.

In an exemplary embodiment, after step S501, it may be continuously determined whether the existing absolute coordinate is valid according to a given cycle. The existing absolute coordinate may mean an absolute coordinate calculated at a previous time point.

In this case, as the determination cycle is shorter, it may be determined in real time whether the positioning error occurs, but a computational amount load may be generated. Accordingly, an optimal determination cycle may be determined and applied by considering a required computational amount and an external environment.

Step S503 is a step of generating a binary matrix Iₖ of setting a corner pixel for a k-th image to 1.

As in FIG. 4, the corner for the k-th image may be detected by using the corner detection algorithm, and the binary matrix may be generated, which allocates the element corresponding to the pixel coordinate of the corner which belongs to the area of interest among the detected corners with 1 and allocates the element which does not correspond to the corner with 0.

Step S505 is a step of calculating a similarity ρ(I₀, Iₖ) between an initial binary matrix I₀ and a k-th binary matrix Iₖ.

In an exemplary embodiment, the similarity ρ(I₀, Iₖ) between the corner matrix I₀ and the k-th corner matrix Iₖ may be measured, which is generated in step S501. Various measurement methods for the similarity are proposed, and as an example, the similarity may be measured as in <Equation 1> by using an inner product for two matrixes.

$$ρ ( {I}_{0} , {I}_{k} ) = \frac{1}{\sqrt{{D}_{0}}} \frac{1}{\sqrt{{D}_{k}}} {\sum }_{m = 1}^{M} {\sum }_{n = 1}^{N} {I}_{0} ( m , n ) \times {I}_{k} ( m , n ) \qquad [ Equation 1 ]$$

Here, D₀ and Dₖ may represent the numbers of 1s of the corner matrix I₀ and the corner matrix Iₖ, respectively, and mean the numbers of corners detected from an initial image and the k-th image used in step 501, respectively. In an exemplary embodiment, I₀ and Iₖ are subjected to the inner product, and normalized to the number of 1s of each matrix.

In this case, it may be determined that the similarity ρ(I₀, Iₖ) has a value between 1 and 1, and two matrixes are similar being close to 1.

Step S507 is a step of comparing the similarity ρ(I₀, Iₖ) calculated in step S505 and a predetermined threshold.

In step S509, when the similarity ρ(I₀, Iₖ) is larger than the threshold, a 0-th image and the k-th image are very similar, so the absolute coordinate is not changed, and as a result, it is determined that a current absolute coordinate is valid and the current absolute coordinate may be maintained. It is possible to wait for a next k+1-th process of determining whether the absolute coordinate is valid according to the given cycle.

In step S511, when the similarity ρ(I₀, Iₖ) is smaller than the threshold, it may be determined that the current absolute coordinate is not valid, and the positioning error calibration may be performed through the calibration.

In an exemplary embodiment, when the similarity ρ(I₀, Iₖ) is smaller than the threshold, it may be determined that the current absolute coordinate is not valid, and a positioning error occurrence message for announcing this may be transmitted to the control server 150. The control server 150 may receive the positioning error occurrence message. In this case, management manpower is dispatched to correct the error to correct the direction of the infrastructure sensor 130. In an exemplary embodiment, the process proceeds to step S501 to perform the calibration for the absolute coordinate of the infrastructure sensor 130 again. This is performed offline, so a considerable time may be required.

Further, in an exemplary embodiment, the infrastructure sensor 130 or the MEC 140 in which a function of performing positioning error detection is installed may perform online calibration for the absolute coordinate 130 again.

For example, in the online calibration, the changed infrastructure sensor direction 302 of FIG. 3 may be calculated as in <Equation 2> through a 2D convolution between the initial corner matrix I₀ and the k-th corner matrix Iₖ.

In this case, a similarity by <Equation 2> may include a similarity based on a direction for acquiring the image of the infrastructure sensor 130.

$${ρ}_{x , y} ( {I}_{0} , {I}_{k} ) = \frac{1}{\sqrt{{D}_{0}}} \frac{1}{\sqrt{{D}_{k}}} {\sum }_{m = 1}^{M} {\sum }_{n = 1}^{N} {I}_{0} ( m , n ) \times {I}_{k} ( m - x , n - y ) \qquad [ Equation 2 ]$$

Here, ρ_{x,y}(I₀, Iₖ) which performs the inner product of the matrix I₀ and the matrix Iₖ which moves in parallel by x pixels in a transverse direction and moves in parallel by y pixels in a longitudinal direction, and normalizes the inner product matrix to the number of 1s of each matrix, may calculate the similarity between the matrix I₀ and the matrix Iₖ which moves in parallel by x pixels in the transverse direction and moves in parallel by y pixels in the longitudinal direction.

When the matrix Iₖ moves in parallel by x=−XH, . . . , XH pixels in the transverse direction and moves in parallel by y=−YV, . . . , YV pixels in the longitudinal direction, a total of (2X_{H})×(2Y_{V}) similarities {ρ_{x,y}(I₀, Iₖ)}_{x=-X}_{_{H}}_{, . . . , X}_{_{H}}_{,y=-Y}_{_{V}}_{, . . . ,Y}_{_{V}} may be obtained. X_{H} and Y_{V} may have values smaller than M and N, respectively, and may be determined by considering the computational amount and an operation environment.

Among a total of (2X_{H})×(2Y_{V}) similarity values {ρ_{x,y}(I₀, Iₖ)}_{x=-X}_{_{H}}_{, . . . , X}_{_{H}}_{,y=-Y}_{_{V}}_{, . . . ,Y}_{_{V}}, ρ_{x,y}(I₀, Iₖ) having a maximum value, and x* and y* may be obtained. In this case, when ρ_{x,y}(I₀, Iₖ) is larger than the threshold used in step 507, it may be determined that the k-th image moves by x* pixels in the transverse direction and moves by y* pixels in the longitudinal direction as compared with the initial image.

By taking the case of FIG. 3 as an example, it may be determined that an original pixel of the center point 301 of the infrastructure sensor 130 moves from (x₀, y₀) by x* pixels in the transverse direction and moves by y* pixels in the longitudinal direction and the center point 302 of the infrastructure sensor 130, of which direction is distorted. Accordingly, an absolute coordinate corresponding to an original pixel (x-x*, y-y*) of the image the absolute coordinate should be mapped to the pixel (X, Y) of the image of which direction is changed. The changed and corrected absolute coordinate is stored as a new absolute coordinate, and the process may proceed to step 501.

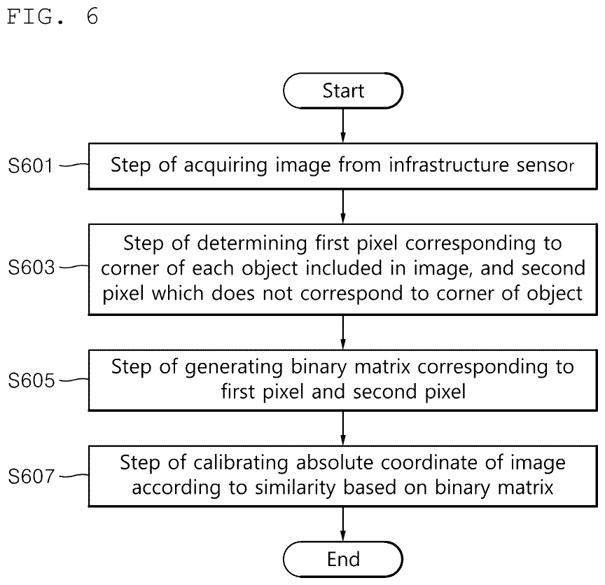

FIG. 6 is a diagram illustrating a method for detecting and correcting positioning errors of sensed objects in infrastructure sensors according to an exemplary embodiment of the present invention. In an exemplary embodiment, each step of FIG. 6 may be performed by an apparatus 700 of FIG. 7.

Referring to FIG. 6, step S601 is a step of acquiring an image from the infrastructure sensor 130.

Step S603 is a step of determining a first pixel corresponding to a corner of each object included in the image, and a second pixel which does not correspond to the corner of the object.

Step S605 is a step of generating a binary matrix corresponding to the first pixel and the second pixel.

In an exemplary embodiment, an element corresponding to an absolute coordinate of the first pixel corresponding to the corner of the object is allocated with 1 and an element corresponding to an absolute coordinate of the second pixel which does not correspond to the corner of the object is allocated with 0 to generate the binary matrix.

Step S607 is a step of calibrating the absolute coordinate of the image according to a similarity based on the binary matrix.

In an exemplary embodiment, a similarity between a binary matrix based on the image at a previous time point and a binary matrix of the image at a current time point may be calculated.

In an exemplary embodiment, when the similarity is larger than a threshold, an absolute coordinate of the image at the current time point may be maintained.

In an exemplary embodiment, when the similarity is smaller than the threshold, a positioning error occurrence message by the infrastructure may be controlled to be transmitted to the control server 150.

In an exemplary embodiment, when the similarity is smaller than the threshold, a similarity based on a direction for acquiring the image of the infrastructure sensor 130 may be calculated according to a 2D convolution of the binary matrix at the previous time point and the binary matrix at the current time point, pixel information corresponding to the similarity based on the direction of the infrastructure sensor 130 may be calculated, and the absolute coordinate of the image at the current time point may be calibrated based on the pixel information.

FIG. 7 is a diagram illustrating a functional configuration of an apparatus 700 for detecting and correcting positioning errors of sensed objects in infrastructure sensors according to an exemplary embodiment of the present invention. In an exemplary embodiment, the apparatus 700 of FIG. 7 may include the infrastructure sensor 130 or the MEC 140 of FIG. 1.

Referring to FIG. 7, the apparatus 700 may include an acquisition unit 710, a control unit 720, and a storage unit 730.

In an exemplary embodiment, the acquisition unit 710 may include a camera. For example, when the apparatus 700 includes the infrastructure sensor 130, the acquisition unit 710 is complemented as the camera to acquire the image through the camera.

In an exemplary embodiment, the acquisition unit 710 may include a communication unit. For example, when the apparatus 700 includes the MEC 140, the acquisition unit 710 is complemented as the communication unit to receive the image from the infrastructure sensor 130.

In an exemplary embodiment, the communication unit may include at least one of a wired communication module and a wireless communication module. A part or the entirety of the communication unit may be referred to as ‘transmitter’, ‘receiver’, or ‘transceiver’.

The control unit 720 may determine a first pixel corresponding to a corner of each object included in the image, and a second pixel which does not correspond to the corner of the object, generate a binary matrix corresponding to the first pixel and the second pixel, and calibrate an absolute coordinate of the image according to a similarity based on the binary matrix.

In an exemplary embodiment, the control unit 720 may include at least one processor or microprocessor, or may be part of the processor. In addition, the control unit 720 may be referred to as a communication processor (CP). The control unit 720 may control an operation of the apparatus 700 according to various exemplary embodiments of the present invention.

The storage unit 730 may store the image. In an exemplary embodiment, the storage unit 730 may be configured by a volatile memory, a non-volatile memory, or a combination of the volatile memory and the non-volatile memory. In addition, the storage unit 730 may provide stored data according to a request of the control unit 720.

Referring to FIG. 7, the apparatus 700 may include an acquisition unit 710, a control unit 720, and a storage unit 730. In various exemplary embodiments of the present invention, since components described in FIG. 7 are not essential, the apparatus 700 may be implemented to have components more than the components described in FIG. 7 or have components less than the components in FIG. 7.

The above description just illustrates the technical spirit of the present invention and various changes and modifications can be made by those skilled in the art to which the present invention pertains without departing from an essential characteristic of the present invention.

The various embodiments disclosed herein may be performed in any order, simultaneously or separately.

In an exemplary embodiment, at least one step may be omitted or added in each figure described in this specification, may be performed in reverse order, or may be performed simultaneously.

The exemplary embodiments of the present invention are provided for illustrative purposes only but not intended to limit the technical spirit of the present invention. The scope of the present invention is not limited to the exemplary embodiments.

The protection scope of the present invention should be construed based on the following appended claims and it should be appreciated that the technical spirit included within the scope equivalent to the claims belongs to the scope of the present invention.

What is claimed is:

1. A method for detecting and correcting positioning errors of sensed objects in real time in infrastructure sensors, the method comprising:
(a) acquiring an image from an infrastructure sensor;
(b) determining a first pixel corresponding to a corner of each object included in the image, and a second pixel which does not correspond to the corner of the object;
(c) generating a binary matrix corresponding to the first pixel and the second pixel; and
(d) calibrating an absolute coordinate of the image according to a similarity based on the binary matrix.

2. The method for detecting and correcting positioning errors of sensed objects in real time in infrastructure sensors of claim 1, wherein step (c) above includes allocating an element corresponding to an absolute coordinate of the first pixel corresponding to the corner of the object with 1 and allocating an element corresponding to an absolute coordinate of the second pixel which does not correspond to the corner of the object with 0 to generate the binary matrix.

3. The method for detecting and correcting positioning errors of sensed objects in real time in infrastructure sensors of claim 1, wherein step (d) above includes
calculating a similarity between a binary matrix based on the image at a previous time point and a binary matrix of the image at a current time point, and
maintaining the absolute coordinate of the image at the current time point when the similarity is larger than the threshold.

4. The method for detecting and correcting positioning errors of sensed objects in real time in infrastructure sensors of claim 3, wherein step (d) above includes controlling a control server to transmit a positioning error occurrence message by the infrastructure sensor when the similarity is smaller than the threshold.

5. The method for detecting and correcting positioning errors of sensed objects in real time in infrastructure sensors of claim 3, wherein step (d) above includes
calculating, when the similarity is smaller than the threshold, a similarity based on a direction for acquiring the image of the infrastructure sensor according to a 2D convolution of the binary matrix at the previous time point and the binary matrix at the current time point,
calculating pixel information corresponding to the similarity based on the direction of the infrastructure sensor, and
calibrating the absolute coordinate of the image at the current time point based on the pixel information.

6. An apparatus for detecting and correcting positioning errors of sensed objects in real time in infrastructure sensors, the apparatus comprising:
an acquisition unit acquiring an image from an infrastructure sensor; and
a control unit determining a first pixel corresponding to a corner of each object included in the image, and a second pixel which does not correspond to the corner of the object, generating a binary matrix corresponding to the first pixel and the second pixel, and calibrating an absolute coordinate of the image according to a similarity based on the binary matrix.

7. The apparatus for detecting and correcting positioning errors of sensed objects in real time in infrastructure sensors of claim 6, wherein the control unit allocates an element corresponding to an absolute coordinate of the first pixel corresponding to the corner of the object with 1 and allocates an element corresponding to an absolute coordinate of the second pixel which does not correspond to the corner of the object with 0 to generate the binary matrix.

8. The apparatus for detecting and correcting positioning errors of sensed objects in real time in infrastructure sensors of claim 6, wherein the control unit
calculates a similarity between a binary matrix based on the image at a previous time point and a binary matrix of the image at a current time point, and
maintains the absolute coordinate of the image at the current time point when the similarity is larger than the threshold.

9. The apparatus for detecting and correcting positioning errors of sensed objects in real time in infrastructure sensors of claim 8, wherein the control unit controls a control server to transmit a positioning error occurrence message by the infrastructure sensor when the similarity is smaller than the threshold.

10. The apparatus for detecting and correcting positioning errors of sensed objects in real time in infrastructure sensors of claim 8, wherein the control unit
calculates, when the similarity is smaller than the threshold, a similarity based on a direction for acquiring the image of the infrastructure sensor according to a 2D convolution of the binary matrix at the previous time point and the binary matrix at the current time point,
calculates pixel information corresponding to the similarity based on the direction of the infrastructure sensor, and
calibrates the absolute coordinate of the image at the current time point based on the pixel information.
